(19) United States
(12) Patent Application Publication
(10) Pub. No.: US 2006/0066096 A1
(43) Pub. Date: Mar. 30, 2006

(54) Adhesive tape structure for sealing and keeping secrecy

(76) Inventor: Shen-Nan Kan, Taipei Hsien (TW)

Correspondence Address: DENNISION, SCHULTZ, DOUGHERTY & MACDONALD, SUITE 105, 1727 KING STREET, ALEXANDRIA, VA, 22314-2700, US

(21) Appl. No.: 10/951,587

(22) Filed: Sep. 29, 2004

(51) Int. Cl. B42D 15/00

(52) U.S. Cl. 283/101

(57) ABSTRACT

An adhesive tape structure for sealing and keeping secrecy comprises a releasable paper film, an upper adhesive layer, a separation layer, a film and a lower adhesive layer sequentially combined downwardly from above; the separation layer has thereon warning letters, when the releasable paper film is torn off, the upper and the lower adhesive layers of the adhesive tape can be stuck respectively on the inner side of the flap and the edge to be sealed at the opening of a bag; and when the edge at the opening of the bag is detached, the separation layer shows the printed letters or pattern for warning. The structure suits postal matters, express delivery bags, package bags and cash bags for sealing and keeping secrecy.

### BACKGROUND OF THE INVENTION

1. Field of the Invention

The present invention is related to an adhesive tape structure for sealing and keeping secrecy, and especially to an adhesive tape structure for sealing and keeping secrecy of which an upper and a lower adhesive tape-layer of the adhesive tape are respectively adhered on the inner side of a flap and an edge to be sealed at the opening of a bag; a separation layer is provided between the two adhesive tape-layers, so that when the sealed opening of the bag is opened, a warning pattern or warning letters can be shown in a way that the body of the bag can be kept intact, and an effect of keeping secrecy and preventing forging can be achieved. The structure suits postal matters, express delivery bags, package bags and cash bags.

2. Description of the Prior Art

Sealing adhesive tapes “a” for receiving and sealing letters or small packs (as shown in FIG. 9) generally are used in the markets presently; in using a sealing adhesive tape “a”, it is stuck on an edge a2 to be sealed at the opening of a bag a1 for making mutual sticking with a flap a3 of the bag a1 to get an effect of sealing the opening. The above stated sealing adhesive tapes “a” generally are divided into two types: one has weaker adhesive power that afford repeated sticking of an edge a2 to be sealed at the opening of a bag a1 on a flap a3, but can not show whether the edge a2 to be sealed has been detached; the other one has stronger adhesive power that can make tight sticking of the edge a2 to be sealed at the opening of a bag a1 to the flap a3, but it has a defect, i.e., once it is detached, the bag a1 loses its intactness.

Besides, manufacturers in this art developed a kind of adhesive tape for keeping secrecy to get an effect of keeping secrecy and preventing forging; such an adhesive tape (being adhesive only on one side thereof) has on this adhesive side a separation layer having thereon printed letters, and is used on the edge to be sealed at the opening of a plastic package bag, cash bag, cardboard or large package; when the adhesive tape is torn off, a mark expressing “having been opened” appears. As shown in FIG. 10, an adhesive tape “b” for keeping secrecy must be stuck from the outside to an edge b2 to be sealed at the opening of a package bag, a cash bag, a cardboard or a package b1, letters or a pattern can be shown on the adhesive tape “b” and the edge b2 at the opening to get an effect of keeping secrecy and preventing forging. However, the adhesive tape “b” being adhesive only on one side thereof can not be used on the inner side of the flap of a postal matter as the sealing adhesive tape “a” can. Therefore, merely a sealing adhesive tape “a” used presently is unable to get the effect of giving a warning pattern or warning letters after detachment of the opening, this is the inadequacy in application of the adhesive tape for preventing forging at the present time.

In view of these, in order to get rid of the above defects, the inventor provided the present invention based on his experience of years after nonstop study and development to render the structure of a sealing adhesive tape for preventing forging to keep intactness of the body of a bag, and also to get an effect of keeping secrecy and preventing forging.

### SUMMARY OF THE INVENTION

The primary object of the present invention is to provide an adhesive tape structure for sealing and keeping secrecy; a separation layer of the structure contains a kind of transparent separating chemical liquid and printed letters, when a flap and an edge at the opening of a package bag or a cash bag are separated, by complete separation of the transparent separating chemical liquid, the flap and the edge at the opening can not be stuck again, and the printed letters on the separation layer can appear; thereby the structure can be used for a non-transparent bag to get an effect of giving warning and keeping intactness of the body of the bag.

The secondary object of the present invention is to provide an adhesive tape structure for sealing and keeping secrecy; the separation layer of the structure contains printed letters or a pattern mixed with a kind of transparent separating chemical liquid, and is applied and arranged partially on a film; a flap and an edge at the opening of a package bag or a cash bag can be stuck again after they are separated, but the printed letters on the flap are located alternate with those on the edge at the opening, thereby the structure can be used for a transparent bag to get an effect of keeping secrecy and preventing forging.

To achieve the above object, an adhesive tape structure for sealing and keeping secrecy of the present invention has a film applied on its bottom with a lower adhesive layer to stick on an edge to be sealed at the opening of the body of a bag; the film is provided on its top with a separation layer having printed letters, the separation layer is applied on its top with an upper adhesive layer, and the upper adhesive layer has on its top an adhesion-proof releasable paper film, thereby, the adhesive tape can be wound to form a roll for use for many times; when the releasable paper film is torn off, the upper and the lower adhesive layers of the adhesive tape can be stuck respectively on the inner side of the flap and the edge to be sealed at the opening; and when the edge at the opening of the bag is detached, the separation layer shows the printed letters or pattern for warning, thus an object of keeping secrecy can be obtained.

The present invention will be apparent after reading the detailed description of the preferred embodiment thereof in reference to the accompanying drawings.

### BRIEF DESCRIPTION OF THE DRAWINGS

FIG. 1 is a sectional view of a first embodiment of the present invention;

FIG. 2 is a sectional view showing the first embodiment of the present invention is stuck on the body of a bag;

FIG. 3 is a sectional view showing the first embodiment of the present invention is stuck respectively on the inner side of a flap and on the edge to be sealed at the opening on the body of the bag;

FIG. 4 is a sectional view showing a flap and an upper adhesive layer of the first embodiment of the present invention are stripped off a separation layer;

FIG. 5 is a perspective schematic view showing the appearance of the first embodiment of the present invention when the flap and the edge at the opening are torn away;

FIG. 6 is a perspective schematic view showing the appearance of a second embodiment of the present invention before sticking of the flap with the edge at the opening;

FIG. 6A is a partially enlarged view of FIG. 6;

FIG. 7 is a perspective schematic view showing the appearance of the second embodiment of the present invention when the flap and the edge at the opening are torn away;

FIG. 7A is a partially enlarged view of FIG. 7;

FIG. 8 is a perspective schematic view showing the appearance of the second embodiment of the present invention after re-sticking of the flap with the edge at the opening;

FIG. 9 is a perspective schematic view showing the state of use of a conventional sealing adhesive tape;

FIG. 10 is a perspective schematic view showing the state of use of a conventional adhesive tape for keeping secrecy.

### DETAILED DESCRIPTION OF THE PREFERRED EMBODIMENT

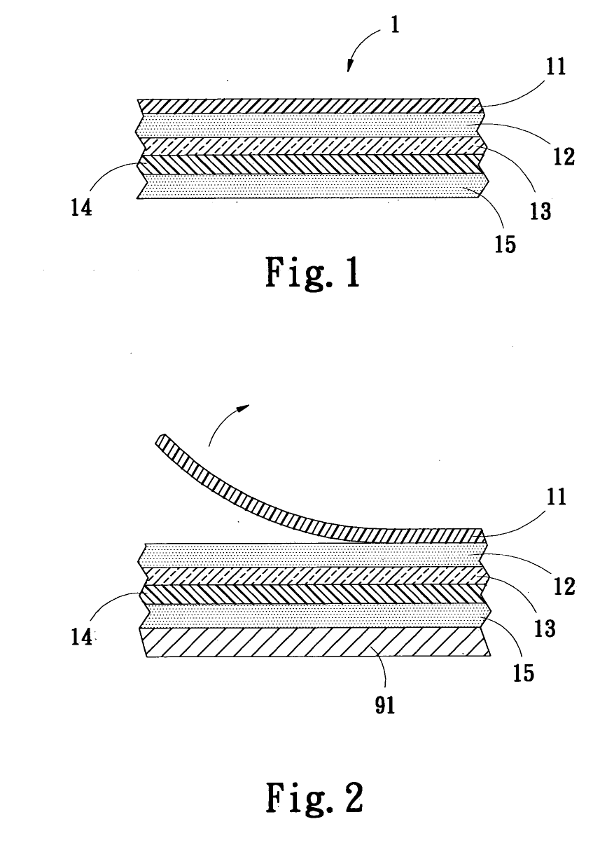

Referring firstly to FIG. 1 showing a first embodiment of adhesive tape structure 1 for sealing and keeping secrecy of the present invention, the structure 1 comprises a releasable paper film 11, an upper adhesive layer 12, a separation layer 13, a film 14 and a lower adhesive layer 15 sequentially combined downwardly from above; Wherein:

The film 14 is applied on its bottom with the lower adhesive layer 15, the film 14 is provided on its top with the separation layer 13 containing therein a kind of transparent separating chemical liquid 131 and printed letters 132 (or a pattern), the separation layer 13 is applied on its top with the upper adhesive layer 12, and the upper adhesive layer 12 has on its top the releasable paper film 11 that is adhesion proof; the width of the film 14 is larger than that of the lower adhesive layer 15, while the width of the lower adhesive layer 15 is larger than that of the upper adhesive layer 12, so that when the adhesive tape 1 is wound to form a roll, glue will not spill outside, and the adhesive tape 1 can be cut for use for many times in pursuance of practical requirement.

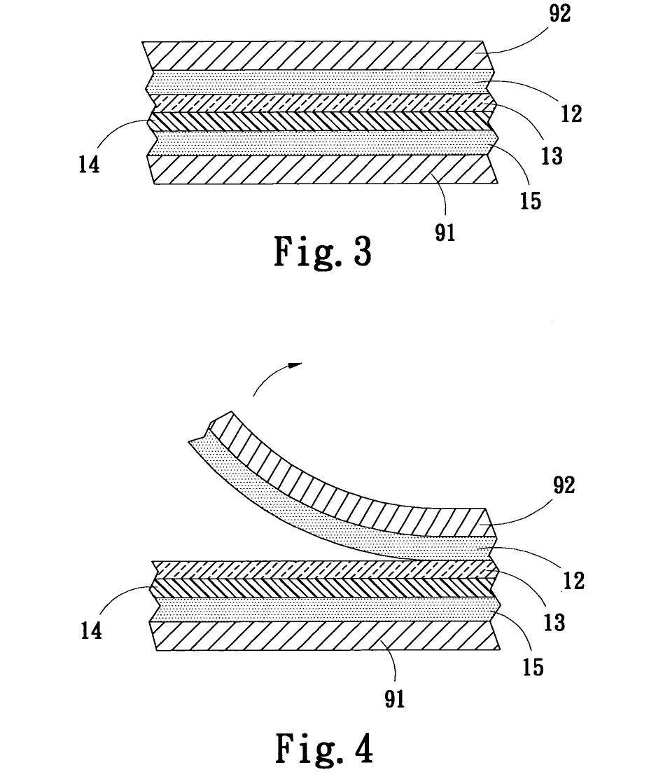

Referring to FIGS. 2 and 3, in using the present invention, the lower adhesive layer 15 of the adhesive tape 1 must be stuck on an edge 91 to be sealed at the opening on the body of a bag 9, then the releasable paper film 11 on the adhesive tape 1 is torn off to reveal the upper adhesive layer 12; after folding a flap 92 of the bag 9, the upper adhesive layer 12 and the inner side of the flap 92 of the bag 9 are mutually stuck.

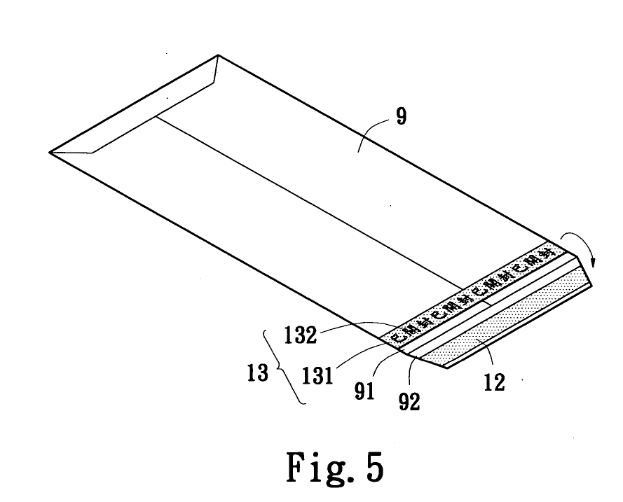

Referring to FIGS. 4 and 5, when the inner side of the flap 92 of the bag 9 and the edge 91 to be sealed at the opening are mutually stuck, the bag 9 which is transparent can receive therein postal matters or precious articles, when the flap 92 of the bag 9 is torn away, by the reason that the adhesion force of the separation layer 13 with the film 14 is larger than that of the separation layer 13 with the upper adhesive layer 12, the inner side of the flap 92 of the bag 9 and the upper adhesive layer 12 can be mutually stuck, but can be stripped away at the separation layer 13; thus the printed letters 132 on the separation layer 13 appear to give a warning function. And more, by separation of the transparent separating chemical liquid 131, the flap 92 and the upper adhesive layer 12 can not be stuck again on the edge 9 at the opening of the bag 9, thereby of the bag 9 is in the opened state.

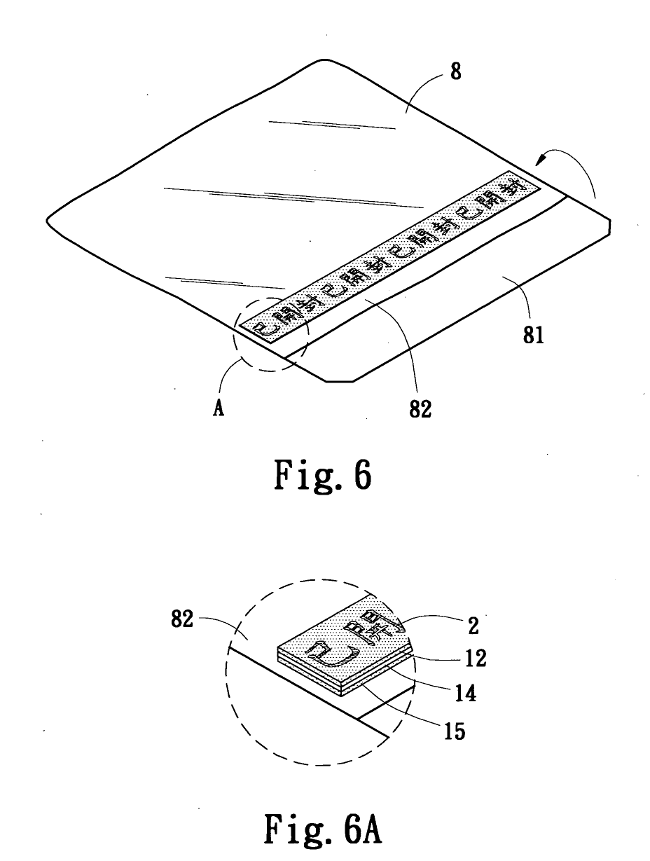

Referring to FIGS. 6 and 6A showing a second embodiment of adhesive tape structure 1 for sealing and keeping secrecy of the present invention, in which the mode of arrangement of all layers is same as that of the first embodiment, the difference between them is resided in that an upper adhesive layer 12 is added with colors, a separation layer 2 contains therein printed letters 132 mixed with transparent separating chemical liquid 131, the printed letters 132 are partially printed and arranged on a film 14.

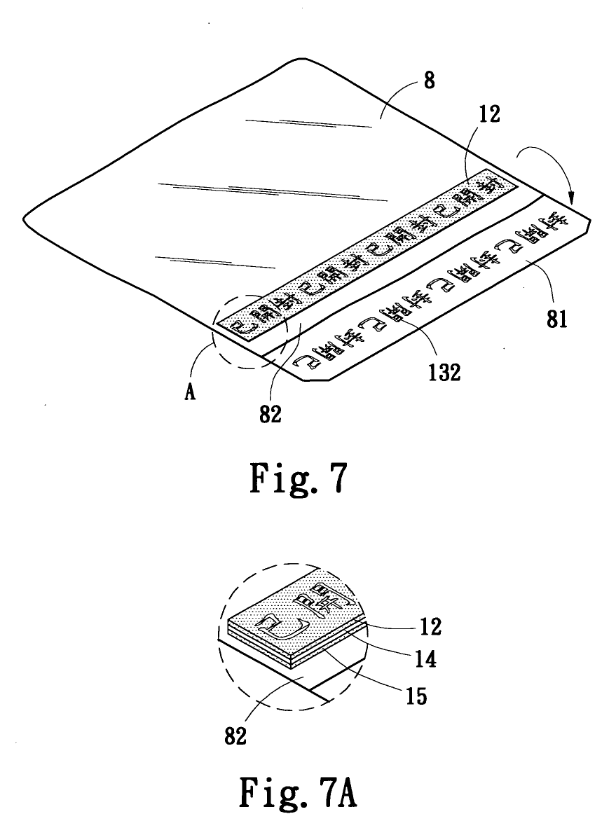

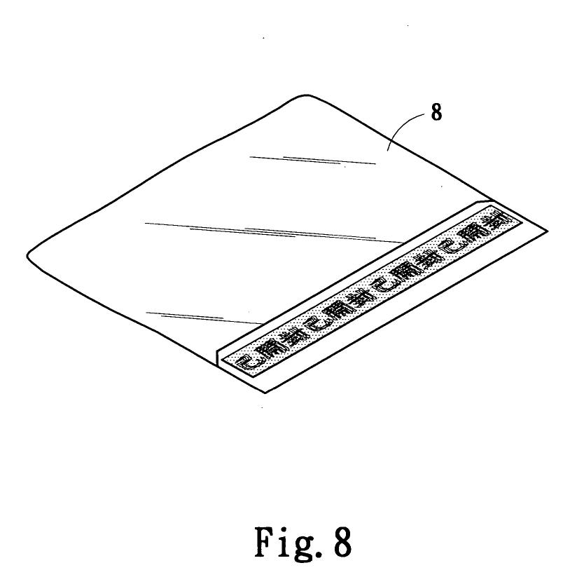

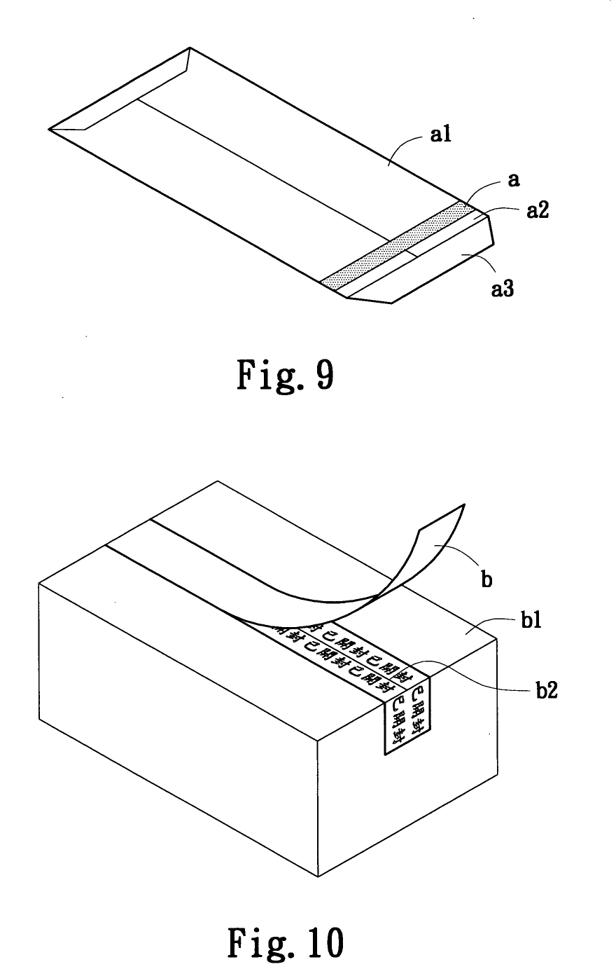

Referring to FIGS. 7-8, this embodiment is applied on a transparent bag 8; when the inner side of a flap 81 of the bag 8 and an edge 82 to be sealed at the opening of the bag 8 are torn away, the adhesion force between the flap 81 and the printed letters 132 is larger than that between the printed letters 132 and the film 14, hence the printed letters 132 and the film 14 can be separated to render the colored and printed letters 132 to be stuck on the inner side of a flap 81, and the light colored and white printed letters 132 remain on the surface of the film 14. Moreover, by the fact that except the light colored and white printed letters 132 being not adhesive, the most area of the film 14 has an upper adhesive layer 12 to still afford sticking the inner side of the flap 81. When the inner side of the flap 81 and the edge 82 at the opening are struck again, the printed letters 132 respectively on the inner side of the flap 81 and the edge 82 are located alternate with each other, they can not be aligned with each other; this evidently expresses that the bag 8 has been opened, thereby effects of warning and keeping secrecy and preventing forging can be achieved.

The present invention thereby has the following advantages:
1. The upper and the lower adhesive layers of the adhesive tape of the present invention can be stuck respectively on the inner side of the flap and the edge to be sealed at the opening of a bag; a separation layer of the adhesive tape containing a kind of transparent separating chemical liquid and printed letters is applied and arranged on a film, the flap and the edge at the opening can not be stuck again if they are separated, and the printed letters on the separation layer can appear, thereby the present invention can be used for a non-transparent bag to get an effect of giving warning and avoiding tearing up of the edge at the opening to keep intactness of the body of the bag.
2. The separation layer of the present invention contains printed letters or a pattern mixed with a kind of transparent separating chemical liquid, and is applied and arranged partially on a film; a flap and an edge at the opening of a bag can be stuck again after they are separated, but the printed letters on the flap are located alternate with those on the edge at the opening and can not be aligned with them, thereby the present invention can be used for a transparent bag to get an effect of keeping secrecy and preventing forging.

In conclusion, the present invention surely can get the expected object thereof to provide an adhesive tape structure for sealing and keeping secrecy, the structure can make the body of a bag be kept intact and can get an effect of keeping secrecy and preventing forging. Therefore, what I claim as new, practicable and desire to be secured by Letters Patent of the United States are:

1. An adhesive tape structure for sealing and keeping secrecy, said structure has a film applied on its bottom with a lower adhesive layer to stick on an edge to be sealed at an opening of a bag; said film is provided on its top with a separation layer having printed letters, said separation layer is applied on its top with an upper adhesive layer, and said upper adhesive layer has on its top an adhesion-proof releasable paper film; thereby, said adhesive tape is adapted for winding to form a roll for use for many times; when said releasable paper film is torn off, said upper and the lower adhesive layers of said adhesive tape are adapted for sticking respectively on an inner side of a flap and said edge to be sealed at said opening; and when said edge at said opening of said bag is detached, said separation layer shows said printed letters or pattern for warning.

2. The adhesive tape structure for sealing and keeping secrecy as in claim 1, wherein said separation layer contains transparent separating chemical liquid and printed letters, and is applied on a film; said bag is a non-transparent envelope, said flap and said edge at said opening are unable to be stuck again when they are separated, and then said printed letters on said separation layer appear.

3. The adhesive tape structure for sealing and keeping secrecy as in claim 1, wherein said separation layer contains printed letters or a pattern mixed with transparent separating chemical liquid, and is applied partially on a film; when said flap and said edge at said opening of said bag are stuck again after being separated, said printed letters on said inner side of said flap are located alternate with said printed letters on said edge at said opening and are unable to be aligned with the latter.

4. The adhesive tape structure for sealing and keeping secrecy as in claim 3, wherein width of said film is larger than that of said lower adhesive layer, while width of said lower adhesive layer is larger than that of said upper adhesive layer.
